(19) United States
(12) Patent Application Publication
(10) Pub. No.: US 2004/0249641 A1
(43) Pub. Date: Dec. 9, 2004

(54) Computer and remote control system using the same

(75) Inventor: Woon-Geun Kwak, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/837,694

(22) Filed: May 4, 2004

(30) Foreign Application Priority Data
May 9, 2003 (KR) 2003-29415

(51) Int. Cl. G10L 11/00

(52) U.S. Cl. 704/275; 370/395.5

(57) ABSTRACT

A computer including a power supply to supply electric power to a system; a power controller that controls the power supply to cut and/or supply electric power; and a remote power control module including a ring signal sensor to sense a ring signal received through a public switched telephone network (PSTN); a data storage to store voice data including a predetermined voice message; a voice message emitter to convert the voice data into a signal compatible with the PSTN and to emit the voice message to the PSTN; and a microprocessor (MICOM) that controls the voice message emitter to emit the voice message to the PSTN when the ring signal is sensed via the ring signal sensor and controls the power supply to supply electric power based on a control signal received from the PSTN corresponding to the voice message. Accordingly, the computer is turned on and/or off using a PSTN.

### CROSS-REFERENCE TO RELATED APPLICATION

This application claims the benefit of Korean Patent Application No. 2003-29415, filed on May 9, 2003, in the Korean Intellectual Property Office, the disclosure of which is incorporated herein by reference.

### BACKGROUND OF THE INVENTION

1. Field of the Invention

The present invention relates to a computer and a remote control system, and more particularly, to a computer that provides a user the convenience of turning on and/or off the computer through a public switched telephone network and that automatically emits network connection information required to connect to a computer through a network and a remote control system using the same.

2. Description of the Related Art

Recently, a method to access a remote computer through the Internet has been used widely. That is, technology to network computers has been developed, which makes data exchange between the computers easier, thereby reducing cost and time needed to exchange data between the computers. To network the computers, it is assumed that a computer to be accessed should be turned on. Thus, to use a remote computer, a technology to turn the remote computer on and to turn the remote computer off after use is required.

### SUMMARY OF THE INVENTION

Accordingly, it is an aspect of the present invention to provide a computer that provides the convenience of turning on and/or off the computer through a public switched telephone network, and that automatically emits network connection information required to connect to a computer through a network and a remote control system using the same.

Additional aspects and/or advantages of the invention will be set forth in part in the description which follows and, in part, will be obvious from the description, or may be learned by practice of the invention.

The foregoing and/or other aspects of the present invention are achieved by providing a computer comprising: a power supply to supply an electric power to a system; a power controller that controls the power supply to cut and/or supply the electric power; and a remote power control module comprising: a ring signal sensor to sense a ring signal received through a public switched telephone network (PSTN); a data storage to store voice data including a predetermined voice message; a voice message emitter to convert the voice data into a signal compatible with the PSTN and to emit the voice message to the PSTN; and a microprocessor (MICOM) that controls the voice message emitter to emit the voice message to the PSTN when the ring signal is sensed by the ring signal sensor and controls the power supply to supply electric power based on a control signal received from the PSTN corresponding to the voice message.

According to an aspect of the invention, the voice message comprises: a password input message to demand a password input, and the MICOM controls the voice message emitter to emit the password input message through the PSTN when the ring signal is sensed by the ring signal sensor.

According to an aspect of the invention, the control signal received through the PSTN comprises a dual tone multi-frequency (DTMF) signal, the remote power control module further comprises a signal converter to convert the DTMF signal received through the PSTN into a digital signal, and the MICOM distinguishes the password received corresponding to the password input message from the converted digital signal by the signal converter, and controls the power controller which controls the power supply to supply the electric power when the password is identical with a preset password.

According to an aspect of the invention, the voice message comprises: a password identifying data to identify whether the received password is identical to a preset password.

According to an aspect of the invention, the remote power control module is connected to the system through a peripheral component interconnect (PCI) bus and the power supply supplies standby electric power through the PCI bus to the remote power control module to operate the remote power control module.

According to an aspect of the invention, the MICOM determines through the PCI bus whether the power supply supplies electric power to the system.

According to an aspect of the invention, the voice message comprises: a power state message in relation to whether the power supply supplies electric power to the system, and the MICOM controls the voice message emitter to emit the power state message through the PSTN when the ring signal is sensed by the ring signal sensor and when sensed that the power supply supplies electric power to the system.

According to an aspect of the invention, the MICOM controls an operating system (OS) of the computer to turn the computer off when the control signal corresponding to the power state message is received from the digital signal converted by the signal converter.

According to an aspect of the invention, the power controller is a super input/output (SIO) to control input/out devices provided to the computer.

According to an aspect of the invention, the computer further comprises: a BIOS ROM to store a BIOS doing power-on self test (POST) and a general purpose input/output (GPIO) having at least one input/output pin connected to the remote power control module, and the remote power control module activates the input/output pin of the GPIO when the remote power control module controls the power controller that the power supply supplies electric power and the BIOS skips an operation to input a complementary metal oxide semiconductor (CMOS) password by checking whether the input/output pin of the GPIO is activated at an operation to do the POST.

The foregoing and/or other aspects of the present invention are also achieved by providing a remote control system comprising: a computer as described above; a remote computer connected to the computer through a network; and a connection supporting server, wherein the computer further comprises a network controller that transmits network connection information to connect the remote computer to the computer through the network and to the connection supporting server through the network when the computer is turned on by the received control signal.

According to an aspect of the invention, the network controller comprises an application program based on the operating system (OS) of the computer.

According to an aspect of the invention, the network connection information comprises an information about Internet Protocol (IP) address of the computer.

According to an aspect of the invention, the connection supporting server comprises a mail server.

According to an aspect of the invention, the connection supporting server supplies the network connection information to a user through a short message service (SMS) when the network connection information is received.

### BRIEF DESCRIPTION OF THE DRAWINGS

The above and/or other aspects and advantages of the invention will become apparent, and more readily appreciated from the following description of the embodiments, taken in conjunction with the accompanying drawings of which:

FIG. 1 shows a structure of a remote control system according to an aspect of the present invention;

FIG. 2 is a control block diagram of a computer according to an aspect of the present invention;

FIG. 3 is a control block diagram of a remote power control module of FIG. 2;

FIG. 4 is a control flow chart of the computer of FIG. 2 according to an aspect of the present invention; and

FIG. 5 is a control flow chart to show a POST of the computer of FIG. 2 according to an aspect of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout.

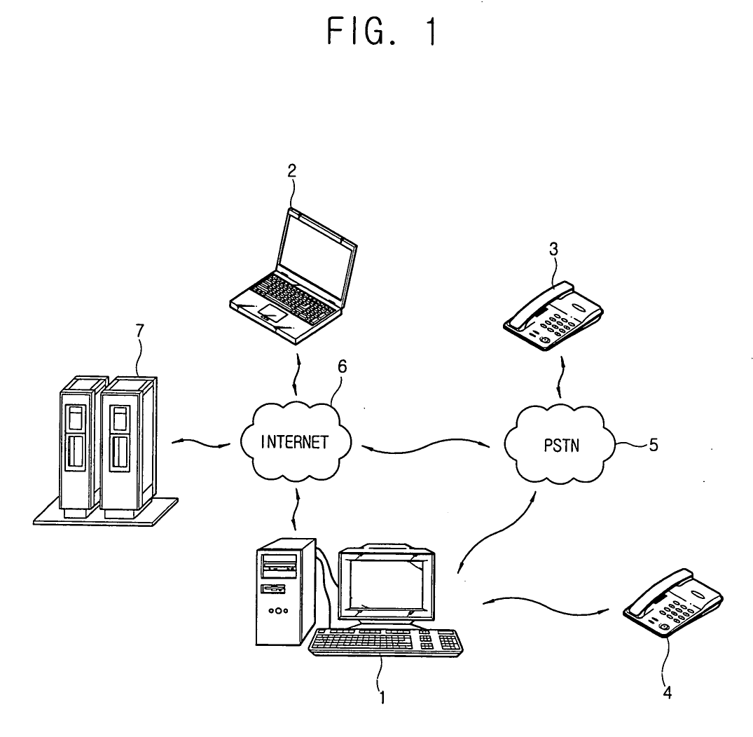

As shown in FIG. 1, a remote control system according to an aspect of the present invention comprises: a computer 1, a remote computer 2 and a connection supporting server 7 connected to the computer 1 and the remote computer 2 through a network such as Internet 6 and the like. The computer 1 is a computer, which a remote user intends to access, and which connects a public switched telephone network (PSTN) 5 to a telephone terminal 4 (hereinbelow, referred to as a local telephone terminal). The remote control system according to an aspect of the present invention further comprises a remote telephone terminal 3 via which a user contacts with the local telephone terminal 4 connected to the computer 1 to turn on/off the computer 1. The remote telephone terminal 3 includes equipment such as a line telephone, a cordless telephone, a cellular phone, a modem installed in a computer, and other devices that may be used to call the local telephone terminal 4 through the PSTN 5.

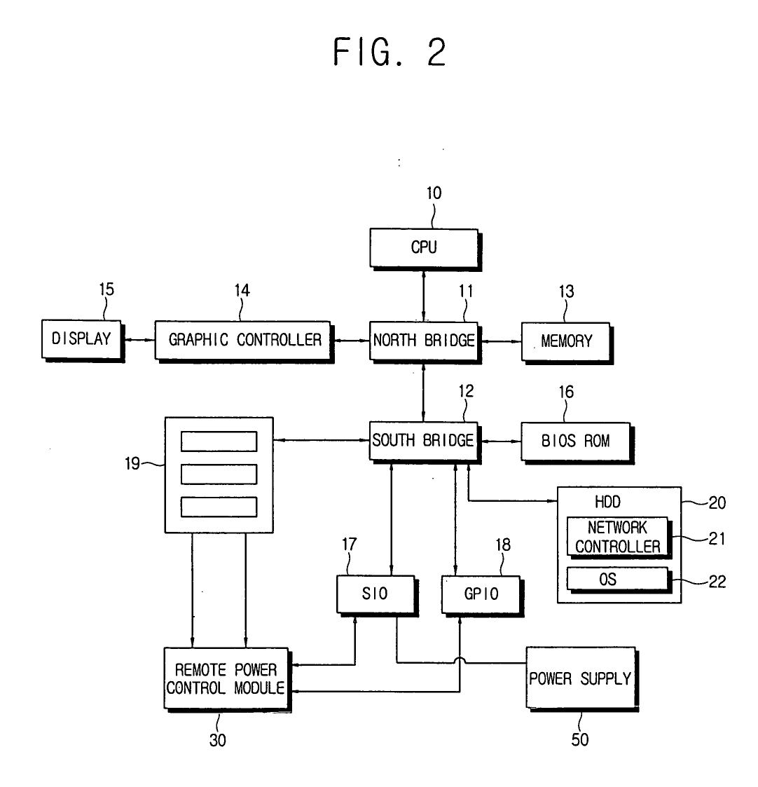

As shown in FIG. 2, the computer 1 according to an aspect of the present invention comprises a central processing unit (CPU) 10, a system memory 13, a north bridge 11 to control the system memory 13, a graphic controller 14, and a south bridge 12 to manage input/output functions.

The north bridge 11, for example a memory control hub (MCH), is connected to the system memory 13 and the graphic controller 14 to control a video signal outputted to a display 15. The south bridge 12, for example an input/output control hub (ICH), is connected to an auxiliary memory, such as a hard disk drive 20, and a super input/output (SIO) 17 to control an input/output device such as a keyboard (not shown), a mouse (not shown) or the like. The south bridge 12 is further connected to a basic input/output system read only memory (BIOS ROM) 16 that stores the BIOS to do a power on self test (POST) and a general purpose input/output (GPIO) 18 having a plurality of input/output pins. The computer 1 according to an aspect of the present invention further comprises a plurality of PCI slots 19 to connect to the south bridge 12 through a PCI bus (not shown). The SIO 17 is used as a power controller to control an electric power supply 50 to supply/cut electric power to a system by sensing whether a power button (not shown) is turned on/off. Hereinbelow, an example in which the SIO 17 is used as a power controller is described, but the present invention is not limited thereto.

The computer 1 according to an aspect of the present invention comprises: a remote power control module 30 connected to the PSTN 5 to allow connection of the PSTN 5 to the local telephone terminal 4.

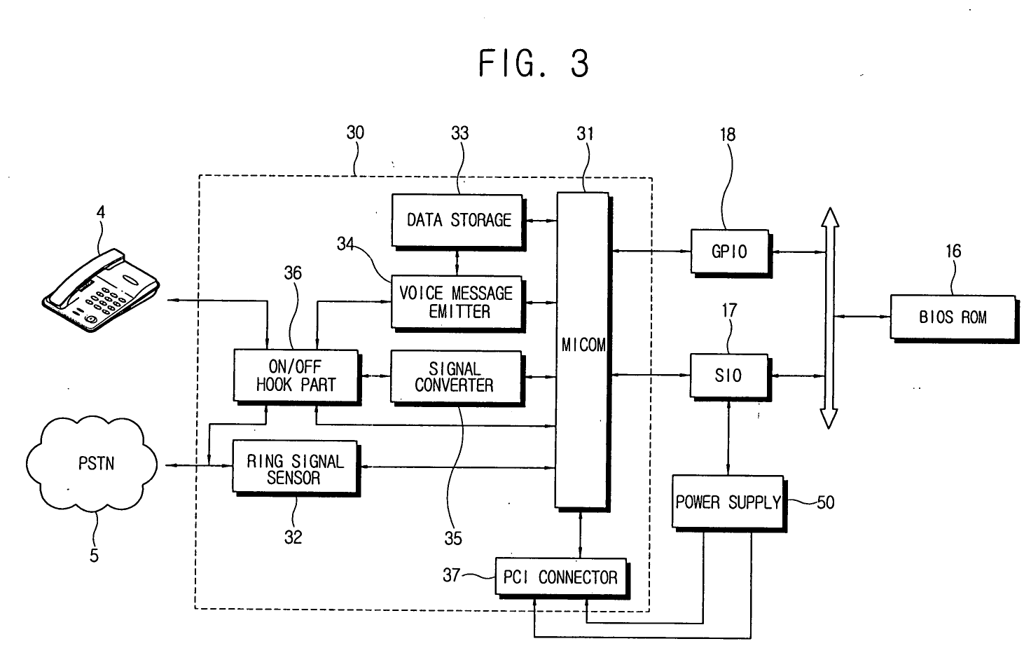

As shown in FIG. 3, the remote power control module 30 comprises: a ring signal sensor 32 to sense a ring signal received from the PSTN 5, a data storage 33 to store voice data including a predetermined voice message, a voice message emitter 34 that reads the voice message from the data storage 33 and converts the voice message into a signal compatible with the PSTN 5 to emit the voice message through the PSTN 5, and a microcomputer (MICOM) 31 to control the ring signal sensor 32, the data storage 33 and the voice message emitter 34.

The ring signal sensor 32 senses a ring signal received from the PSTN 5 when a remote user calls the local telephone terminal 4 by using the remote telephone terminal 3 to turn the computer 1 on.

The voice message emitter 34 is controlled by the MICOM 31. The voice message emitter 34 reads voice data as a digital signal from the data storage 33 and converts the read voice data into an analog signal compatible with the PSTN to emit the analog signal to the PSTN 5. Thus, the remote user is able to hear a voice message corresponding to the voice data through the remote telephone terminal 3.

The voice data stored in the data storage 33 comprises a variety of voice messages to be transmitted to the remote telephone terminal 3 through the PSTN 5. For example, the voice data may comprise a password input message that demands a password input, a password identifying message to identify whether the password is correct or a power state message related to a power state of the computer 1, which provides a variety of voice messages to remotely turn on the computer 1, thereby providing convenience to the remote user who wants to turn the computer on. The variety of voice messages to remotely turn on the computer 1 described hereinbelow.

The MICOM 31 controls the voice message emitter 34 to emit a voice message through the PSTN 5 when a ring signal is sensed by the ring signal sensor 32 and outputs a remote power control signal to control the SIO 17 as a power controller that the power supply 50 supplies electric power based on a control signal received from the PSTN 50 corresponding to the voice message. The control signal received from the PSTN 5 comprises a dual tone multifrequency receiver (DTMF) signal emitted to the PSTN 2 corresponding to buttons of the remote telephone terminal 3 when the remote user pushes the buttons of the remote telephone terminal 3.

According to an aspect of the present invention, the remote power control module 30 further comprises a signal converter 35 to convert the DTMF signal received from the PSTN 5 into a digital signal. When the remote user pushes the buttons of the remote telephone terminal 3 corresponding to the voice message supplied from the remote power control module 30 through the PSTN 5, the DTMF signals corresponding to the password and the like are transmitted to the remote power control module 30, and the MICOM 32 of the remote power control module 30 operates the functions described above based on the DTMF signals converted by the signal converter 35.

According to an aspect of the present invention, the remote power control module 30 comprises an on/off hook part by which the local telephone terminal 4 is on/off the hook 36. The MICOM 31 controls the on/off hook part 36 to determine that the local telephone terminal 4 is off the hook, or when the local telephone terminal 4 is not off the hook but a predetermined time passes from a point at which the ring signal is received or the ring signal is continuously received for a predetermined time. Thus, the local telephone terminal 4 is off the hook and no longer rings no more due to the ring signal, so that the remote power control module 30 is operated in the state that the local telephone terminal 4 is off the hook.

According to an aspect of the present invention, the remote power control module 30 comprises a PCI connector 37 detachably connected to a PCI slot 19, which connects the remote power control module 30 to a system through the PCI bus (not shown). The power supply 50 supplies standby electric power through the PCI bus to operate the remote power control module 30.

The MICOM 31 determines through the PCI bus whether a main power is supplied to operate the computer 1. Upon determining that the main power is supplied to the system and the ring signal is sensed, the MICOM 31 controls the voice message emitter 34 to supply the power state message to inform the remote user that the computer 1 is turned on through the PSTN 5. Thus, the user is informed that the computer 1 is turned on. And when the user wants to turn the computer 1 off, the user transmits the DTMF signal corresponding thereto and turns the computer 1 off.

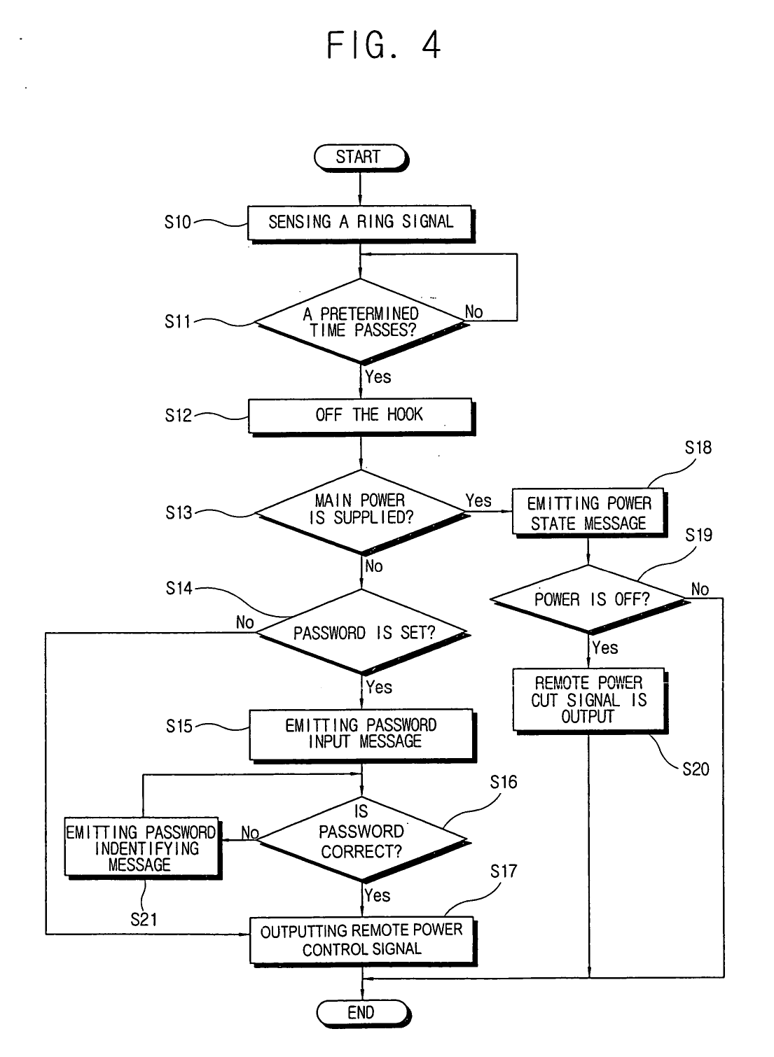

In FIG. 4, a description of an operation to turn the computer 1 on using the PSTN 5 according to a configuration described above is shown.

When a remote user calls the local telephone terminal 4 using the remote telephone terminal 3 to turn the computer 1 on, a ring signal is received by the remote power control module 30 and the local telephone terminal 4 through the PSTN 5. At this time, the ring signal received from the PSTN 5 is sensed by the ring signal sensor 32 at operation S10 and the MICOM 31 controls the on/off hook 36 at operation S12 to determine that the local telephone terminal 4 is off the hook, or when the local telephone terminal 4 is determined to be not off the hook when a predetermined time passes from a point at which the ring signal is received.

The MICOM 31 determines whether a main power is supplied from the power supply 50 through the PCI bus, i.e., whether the computer 1 is turned on at operation S13. When it is sensed through the PCI bus that main power is supplied from the power supply 50, the MICOM 31 controls the voice message emitter 34 to read the voice data from the data storage 33 at operation S18, where the voice data corresponds to the power state message to inform that the power is on. Thus, the remote user is informed that the computer 1 is turned on through the power state message. When it is sensed through the PCI bus that the main power is not supplied, the MICOM 31 determines that the computer 1 is turned off.

When the MICOM 31 determines that the computer 1 is turned off, the MICOM 31 determines whether a password is set in the remote power control module 30 at operation S14. When determined that a password is set in the remote power control module 30, the MICOM 31 controls the voice message emitter 34 to emit a password input message to demand a password input through the PSTN 5 at operation S15. That is, the MICOM 31 controls the voice message emitter 34 to read voice data corresponding to the password input message from the data storage 33 and to transmit the voice data. When the remote user hears the password input message from the remote telephone terminal 3, the remote user inputs the password by pushing buttons of the remote telephone terminal 3. The password inputted by the remote user is received as a DTMF signal to the remote power control module 30 through the PSTN 5 and the signal converter 35 of the remote power control module 30 converts the received DTMF signal into a digital signal. Here, the MICOM 31 differentiates the password from the converted digital signal by the signal converter 35 and determines whether the password is identical to the preset password at operation S16. When it is determined that the password is identical to the preset password, the MICOM 31 outputs a remote power control signal to the SIO 17 at operation S17.

When determined that the password is not identical to the preset password, the MICOM 31 controls the voice message emitter 34 to emit a password identifying message to notify that the password is not identical to the preset password through the PSTN 5 at operation S21. Further, the MICOM 31 controls the voice message emitter 34 to emit a voice message to demand a password input again through the PSTN 5, which notifies the remote user that the entered password is not identical to the preset password and prompts the user to input a password again.

When determined that a password is not set in the remote power control module 30 at operation S14, the MICOM 31 outputs a remote power control signal to the SIO 17 to turn the computer 1 on at operation S17.

According to an aspect of the present invention, when the power state message is emitted through the PSTN 5 at operation S18, the MICOM 31 emits a message to confirm whether the remote user turns the computer 1 off. At this time, if the remote user wants to turn the computer 1 off, the remote user emits a control signal corresponding thereto through the remote telephone terminal 3. Then, the MICOM 31 turns the computer 1 off in accordance with the control signal received through the PSTN 5. Here, when the control signal corresponding to turning the computer 1 off is received, the MICOM 31 outputs a remote power cut signal to an operating system (OS) of the computer 1 at operation S20 and the OS of the computer 1 turns the computer 1 off based on the remote power cut signal received from the remote power control module 30.

The computer 1 according to an aspect of the present invention further comprises the GPIO 18 having at least one input/output pin connected to the remote power control module 30. According to an aspect of the present invention, the remote power control module 30 activates the input/output pin of the GPIO 18 when the ring signal is sensed. At an operation to do the POST, the BIOS checks whether the input/output pin of the GPIO 18 is activated by the remote power control module 30. When determined that the input/output pin of the GPIO 18 is activated, the BIOS skips an operation to input a CMOS password and does the POST.

According to an aspect of the present invention, the computer 1 further comprises a network controller 21 to transmit network connection information to connect the remote computer 2 to the computer 1 through a network to the connection supporting server 7 through the network, when the computer 1 is turned on by an operation of the remote power control module 30 as described above. According to an aspect of the present invention, the network connection information transmitted by the network controller 21 includes information required to connect the remote computer 2 to the computer 1 through the network such as an information of an Internet protocol (IP) address and the like. According to an aspect of the present invention, the network controller 21 is an application program operated based on the OS 22 of the computer 1.

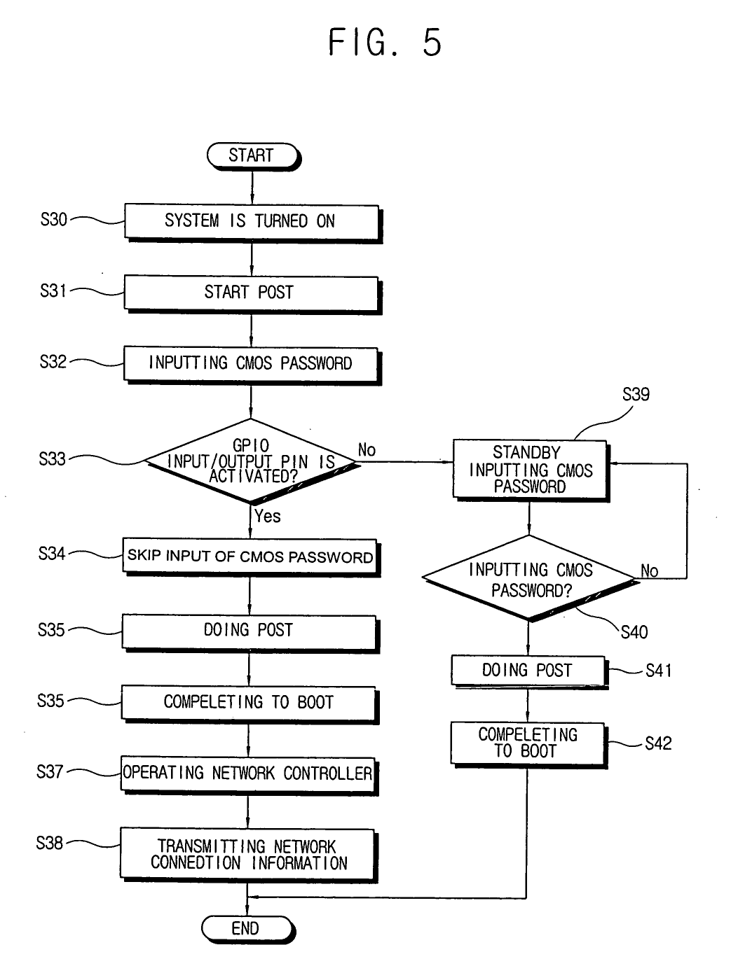

According to a configuration as described above, a description of an operation after the computer 1 is turned on is given with reference to FIG. 5.

When the ring signal is received by the remote power control module 30 and the remote power control module 30 controls the SIO 17 to turn the computer 1 on, the SIO 17 controls the power supply 50 to supply electric power to the system at operation S30. When determined that the main power is supplied to the system, a control of the system is transferred from the CPU 10 to the BIOS stored in the BIOS ROM 16. The BIOS does the POST to check positions and operating states of hardware installed in the system at operation S31.

During the POST, in the state to input the CMOS password at operation S32, the BIOS checks whether the input/output pin connected to the remote power control module 30 is activated among the input/output pins of the GPIO 18 at operation S33. When determined that the input/output pin of the GPIO 18 is activated, the BIOS skips an operation to input the CMOS password at operation S34 and does the POST at operation S35. Thus, when the remote user turns on the computer 1 using the PSTN 5, it is prevented that the computer 1 is not turned on by the operation to input the CMOS password.

Thereafter, when the POST is completed by skipping the operation to input the CMOS password, the OS 22 of the computer 1 is operated and the control of the system is transferred to the OS 22, thereby completing to boot the computer 1 at operation S35.

Here, when the computer 1 is completely booted, the network controller 21 is operated at operation S37 and the network controller 21 transmits the network connection information to the connection supporting server 7 through the network at operation S38. The connection supporting server 7 may comprise a mail server. For example, the network controller 21 transmits the network connection information to a mail address a user previously registered and the remote user logs in the mail server and confirms the network connection information such as the IP address. The connection supporting server 7 may provide a short message service (SMS). That is, if the network connection information is received from the computer 1, the connection supporting server 7 may retransmit the network connection information to a cellular phone and the like of the remote user, so that the user immediately confirms the network connection information of the computer 1.

The operations S39, S40, S41 and S42 in FIG. 5 illustrate a process to boot the computer 1 by inputting the CMOS password through an input device such as a keyboard and the like, if the input/output pin of the GPIO 18 is not activated and the computer 1 is turned on by a general operation of a power button.

As described above, the SIO 17 receives the remote power control signal from the remote power control module 30 and a power controller controls an electric power supply to supply and/or cut electric power, but the present invention is not limited thereto. Power controllers to control the power supply 50 by sensing that the power button is turned on/off may be applied to the computer system of the present invention, without providing a power controller such as a chip set, an input/output controller, and other similar operations and/or devices.

Further, the network connection information required to connect to the computer 1 through the network is automatically emitted, so that the remote user can easily connect to the computer 1.

As described above, the present invention provides the computer that can be turned on/off by using the PSTN.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A computer, comprising:
a power supply to supply an electric power to a system;
a power controller that controls the power supply to cut and/or supply the electric power; and
a remote power control module, comprising:
a ring signal sensor to sense a ring signal received through a public switched telephone network,
a data storage to store voice data including a predetermined voice message,
a voice message emitter to convert the voice data into a signal compatible with the public switched telephone network and to emit the voice message to the public switched telephone network, and
a microprocessor that controls the voice message emitter to emit the voice message to the public switched telephone network when the ring signal is sensed by the ring signal sensor and controls the power supply to supply electric power based on a control signal received from the public switched telephone network corresponding to the voice message.

2. The computer according to claim 1, wherein the voice message comprises:
a password input message to demand a password input, wherein the microprocessor controls the voice message emitter to emit the password input message through the public switched telephone network when the ring signal is sensed by the ring signal sensor.

3. The computer according to claim 2, wherein the control signal received through the public switched telephone network comprises a dual tone multi-frequency signal, and the remote power control module further comprises:
a signal converter to convert the dual tone multi-frequency signal received through the public switched telephone network into a digital signal, and
wherein the microprocessor distinguishes the password received corresponding to the password input message from the converted digital signal by the signal converter, and controls the power controller so that the power supply supplies the electric power when the password is identical to a preset password.

4. The computer according to claim 3, wherein the voice message comprises:
a password identifying message to identify whether the received password is identical to a preset password.

5. The computer according to claim 4, wherein the remote power control module is connected to the system through a peripheral component interconnect bus and the power supply supplies standby electric power through the peripheral component interconnect bus to the remote power control module to operate the remote power control module.

6. The computer according to claim 5, wherein the microprocessor determines through the peripheral component interconnect bus whether the power supply supplies the electric power to the system.

7. The computer according to claim 6, wherein the voice message comprises:
a power state message in relation to whether the power supply supplies the electric power to the system, and
the microprocessor controls the voice message emitter to emit the power state message through the public switched telephone network when the ring signal is sensed by the ring signal sensor and sensed that the power supply supplies the electric power to the system.

8. The computer according to claim 7, wherein the microprocessor controls an operating system of the computer to turn the computer off when the control signal corresponding to the power state message is received from the digital signal converted by the signal converter.

9. The computer according to claim 1, wherein the power controller is a super input/output to control input/out devices provided to the computer.

10. The computer according to claim 1, further comprising:
a basic input/output system read only memory to store a basic input/output system doing power on self test; and
a general purpose input/output having at least one input/output pin connected to the remote power control module,
wherein the remote power control module activates the input/output pin of the general purpose input/output if the remote power control module controls the power controller that the power supply supplies the electric power and the basic input/output system skips an operation to input a complementary metal oxide semiconductor password by checking whether the input/output pin of the general purpose input/output is activated at an operation to do the power on self test.

11. A remote control system, comprising:
a computer comprising:
a power supply to supply an electric power to a system,
a power controller that controls the power supply to cut and/or supply the electric power,
a remote power control module comprising:
a ring signal sensor to sense a ring signal received through a public switched telephone network;
a data storage to store voice data including a predetermined voice message;
a voice message emitter to convert the voice data into a signal compatible with the public switched telephone network and to emit the voice message to the public switched telephone network; and
a microprocessor that controls the voice message emitter to emit the voice message to the public switched telephone network when the ring signal is sensed by the ring signal sensor and controls the power supply to supply the electric power based on a control signal received from the public switched telephone network corresponding to the voice message;
a remote computer connected to the computer through a network; and
a connection supporting server
wherein the computer further comprises a network controller that transmits network connection information to connect the remote computer, the computer, and the connection supporting server through the network when the computer is turned on by the received control signal.

12. The remote control system according to claim 11, wherein the network controller comprises:
an application program based on an operating system of the computer.

13. The remote control system according to claim 11, wherein the network connection information includes information about an Internet Protocol address of the computer.

14. The remote control system according to claim 13, wherein the connection supporting server comprises:
a mail server.

15. The remote control system according to claim 13, wherein the connection supporting server supplies the network connection information to a user through a short message service when the network connection information is received.

16. The computer according to claim 1, comprising:
a super input/output used as the power controller to control the electric power supply to supply and/or cut the electric power to the system by sensing whether a power button is turned on/off.

17. The computer according to claim 1, wherein the voice message emitter reads the voice data as a digital signal from the data storage, and converts the read voice data into an analog signal to emit the analog signal to the public switched telephone network.

18. The computer according to claim 1, the control signal received includes a dual tone multifrequency signal corresponding to buttons of a telephone terminal when a user presses the buttons of the telephone terminal.

19. The computer according to claim 11, wherein the network connection information to connect the remote computer is automatically transmitted.

20. A remote control system, comprising:
a computer comprising:
a remote power control module including:
a ring signal sensor to sense a ring signal received through a public switched telephone network,
a data storage to store voice data including a predetermined voice message,
a voice message emitter to convert the voice data into a signal compatible with the public switched telephone network and to emit the voice message to the public switched telephone network, and
a microprocessor that controls the voice message emitter to emit the voice message to the public switched telephone network when the ring signal is sensed by the ring signal sensor, and controls an electric power supplied to the computer based on a control signal received from the public switched telephone network corresponding to the voice message.

21. The remote control system according to claim 20, comprising:
a local telephone terminal connected to the public switched telephone network via the computer.

22. The remote control system according to claim 21, further comprising:
a remote telephone terminal, wherein the ring signal sensor senses the ring signal received from the public switched telephone network when a user calls the local telephone terminal via the remote telephone terminal.

23. The remote control system according to claim 22, wherein the voice message emitter reads the voice data as a digital signal from the data storage, and converts the read voice data into an analog signal to emit the analog signal to the public switched telephone network.

24. The remote control system according to claim 22, wherein the control signal includes a dual tone multifrequency signal corresponding to buttons of the remote telephone terminal when a user presses the buttons of the remote telephone terminal.

25. The remote control system according to claim 24, wherein the remote power control module further comprises:
a signal converter to convert the dual tone multi-frequency signal received through the public switched telephone network into a digital signal.

26. The remote control system according to claim 25, wherein when the user pushes the buttons of the remote telephone terminal based on the voice message supplied from the public switched telephone network, the corresponding dual tone multifrequency signals are transmitted to the remote power control module and the microprocessor operates corresponding functions based on the dual tone multifrequency signals converted by the signal converter.

27. The remote control system according to claim 26, wherein the voice message comprises:
a power state message to indicate whether the computer is supplied with the electric power, wherein the microprocessor controls the voice message emitter to emit the power state message through the public switched telephone network.

28. The remote control system according to claim 27, wherein the microprocessor controls an operating system of the computer to turn the computer on/off based on the control signal.

29. A computer connected with a public switched telephone network, comprising:
a power supply to supply an electric power to the computer; and
a power controller to control the electric power supplied to the computer based on a control signal received through the public switched network.
